(19) United States
(12) Patent Application Publication
(10) Pub. No.: US 2024/0354558 A1
(43) Pub. Date: Oct. 24, 2024

(54) SIMPLICIAL HUMAN-INSPIRED PATTERN IDENTIFICATION

(71) Applicant: Bank of America Corporation, Charlotte, NC (US)

(72) Inventors: Justin Horowitz, Fort Mill, SC (US); Melissa Podrazka, Chicago, IL (US)

(21) Appl. No.: 18/135,819

(22) Filed: Apr. 18, 2023

(51) Int. Cl. G06N 3/063

(52) U.S. Cl. CPC G06N 3/063

(57) ABSTRACT

A method for generating a simplex from a plurality of neurons is provided. Methods may receive the neurons. Each neuron may encode a data point. Methods may receive a new data point and project the new data point on the neurons. A reconstruction error value may be generated from the projection of the new data point onto the neurons. The reconstruction error value may quantify the new data point. Methods may include creating a coactivation matrix for the neurons and the reconstruction error value. Methods may invert the coactivation matrix, and identify, from the inverted coactivation matrix, coordinates for each end point of a simplex. Methods may generate a simplex from the coordinates. Methods may receive a data structure and plot the data structure within the simplex. Methods may identify a correspondence value between the data structure and the end points, the correspondence values may add up to 100%.

### FIELD OF TECHNOLOGY

Aspects of the disclosure relate to artificial intelligence. Specifically, aspects of the disclosure relate to labeling data to be used in artificial intelligence networks.

### BACKGROUND OF THE DISCLOSURE

It the space of artificial intelligence, neurons are used to form neural networks. Many times, the neurons are connected to one another using a web of chain-like connections. Each subsequent neuron, on the chain, attempts to correct errors made by previous neurons. However, it should be noted that typically neurons, within a neural network, do not work together.

Therefore, it would be desirable for an artificially intelligence environment that is able to map data from neurons onto a data structure. It would be desirable for such a data structure to take one or more neurons and create a combination space. It would be desirable for the combination space to incorporate the one or more neurons. It would be further desirable for the combination space to enable the neurons to work together to understand a new unlabeled data point, define the new unlabeled data point and separate the new unlabeled data point into its component parts. It would yet be further desirable to map the new unlabeled data point onto the combination space to understand where the unlabeled data point fits within the combination space.

### SUMMARY OF THE DISCLOSURE

An artificially intelligent environment is provided. The artificially intelligent environment may receive neurons. The neurons may correspond to and/or encode experiences. A previous experience may also be referred to as a naïve prior, or evidence that is previously known or believed before new evidence was introduced. It should be noted that previously the neurons may operate within a neural network, in which each neuron may correct errors made by previous neurons, however, neither the individual neurons, nor the neural network as a whole, was able to understand how the neurons fit together to create a combination space.

The combination space may be formed by a plurality of neurons. A first neuron, which represents a first experience, may be connected to a second neuron, which represents a second experience. A line may be drawn between the first neuron and the second neuron. A third neuron, which represents a third experience, may be connected to the first neuron and the second neuron. The addition of the third neuron to the combination space may form a triangle. The addition of a fourth or higher order number of neurons may form an n-sided triangle, also referred to as a polyhedron or simplex.

Each additional data point may be plotted on the polyhedron as it compares to the already-plotted neurons. The reconstruction error between the additional data point and the already-plotted neurons may be a way to quantify the additional data point.

A coactivation matrix, which may be named “T”, may be generated from the neurons (including the new data point). T⁻¹, which may be used in a further calculation, may be identified by inverting T. The coactivation matrix may be converted into the combination space using multiplication of T⁻¹.

The triangle, polyhedron or simplex may form the combination space, in which a data point may be plotted within the space or external to the space. If a data point plots somewhere within the space, the data point may be broken down into a blend of as many neurons as the space in which it falls. If a data point plots somewhere on a line segment, the data point may be broken down into a blend of the two neurons which are connected by the line segment.

As such, the artificially intelligent environment may be able to receive neurons encoded as line segments and generate a pie chart encoder, which can be used to classify a new experience.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIG. 2 shows another illustrative diagram in accordance with principles of the disclosure;

FIG. 3 shows yet another illustrative diagram in accordance with principles of the disclosure;

FIG. 4 shows still another illustrative diagram in accordance with principles of the disclosure;

FIG. 5 shows yet another illustrative diagram in accordance with principles of the disclosure;

FIG. 6 shows yet another illustrative diagram in accordance with principles of the disclosure; and

FIG. 7 shows still yet another illustrative diagram in accordance with principles of the disclosure.

### DETAILED DESCRIPTION OF THE DISCLOSURE

Apparatus and methods for generating a simple from a plurality of neurons is provided. Apparatus and methods may use one or more hardware processors, hardware receivers, hardware memories. The hardware processors, hardware receivers and/or hardware memories may work in tandem with each other.

Initially, methods may identify, using an optimization problem shown in Equation A that triangular neurons serve as representers.

$${min}_{f} J ( f ) = {\sum }_{i = 1}^{2} {( {u}_{i} - f ( {u}_{i} ) )}^{2} \qquad Equation A$$

The solution to equation A may be shown as Equation B.

$$f ( x ) = {\sum }_{i = 1}^{2} {a}_{i} K ( x , {u}_{i} ) \qquad Equation B$$

To test a particular K, Equation C is used.

$${κ}_{i} ( x ) = {κ}_{i} ( x , {u}_{i} ) := max ( 0 , 1 - \vert s \cdot ( x - {u}_{i} ) \vert ) \qquad Equation C$$

A Mercer Kernel may have two requirements: Symmetry and Positive Definiteness. K may satisfy both requirements as shown in Equation D.

Equation D:

Symmetry: K(x,uᵢ)=K(uᵢ,x) 1

Positive definiteness: 0≤K 2

A method may fit a line segment between a point labeled u₁ and u₂ using the points as representers with *s⁻¹=|u₁−u₂|. x may be a point on the line segment.

Equation/Matrix E may be in effect when Kᵢ(uᵢ)=1 and Kᵢ(uᵢ=0 for all i≠j, aᵢ=yᵢ.

$$[ \begin{matrix}{u}_{1} \\ {u}_{2} \\ x\end{matrix} ] = [ \begin{matrix}1 & 0 \\ 0 & 1 \\ {κ}_{1} ( x ) & {κ}_{2} ( x )\end{matrix} ] [ \begin{matrix}{u}_{1} \\ {u}_{2}\end{matrix} ] \qquad Equation / Matrix E$$

As such, there may be a special representer that may require no fitting. This may be isomorphic to classic one-dimensional interpolation. Furthermore, K may describe an optimal autoencoder, K may capture any associated dependent variables. f and K may require no fitting or free parameters.

In order to generalize a one-dimensional pair to a multi-dimensional pair, a simplex may be used. It should be noted that the following two conditions may define a simplex. The two conditions may be orthogonality (Kᵢ(uᵢ)=1 and Kᵢ(uᵢ)=0 for all i≠j) and weighted average may be

$${\sum }_{i = 1}^{I} {κ}_{i} = 1$$

when x is “in between” u).

In order to generate a simplex, λ=T⁻¹S₁ may convert one-dimensional interpolations to triangles. Without T⁻¹, the conditions may not be satisfied. T⁻¹ may be the inverse of the coactivation matrix.

Therefore, reconstruction error values may be converted to coordinate systems, such as a simplex.

A method for naïve tessellation of a topologically continuous subspace may be provided. The method may include receiving a plurality of data points. The method may include assigning each data point included in the plurality of points a zero value. The method may include identifying that a first data point, included in the plurality of data points, is not a second data point, included in the plurality of data points.

The method may include encoding a line segment between the first data point and the second data point. The method may include encoding a line segment between the first data point and the second data point. The method may include reconstructing each of the plurality of data points by projecting each of the plurality of data points onto the line segment.

The method may include identifying that a third data point, included in the plurality of data points, includes a component that is orthogonal to a first simplex, a second simplex, a third simplex and a fourth simplex. The first simplex, second simplex, third simplex and fourth simplex may be one-dimensional simplexes. The first simplex may encode the first data point. The second simplex may encode the second data point. The third simplex may encode a line segment between the first data point and the second data point. The fourth simplex may encode zero.

A second line segment may encode the third data pint, the first line segment and the third data point, in sequence. The method may include using the line segment, the second line segment, the first simplex, the second simplex, the third simplex and the fourth simplex to form a reconstruction error value.

The method may include using the reconstruction error value, the line segment, the second line segment, the first simplex, the second simplex, the third simplex and the fourth simplex to generate a two-dimensional simplex.

The corners of the two-dimensional simplex may be the first data point, the second data point and the third data point.

The corners of the two-dimensional simplex may be calculated by T⁻¹ S₁, where S may be the simplex, T may be a coactivation matrix, a may be the first data point, b may be the second data point and c may be the third data point:

$$\begin{matrix}{S}_{1} & = & T & λ \\ [ \begin{matrix}\frac{1}{ab} \\ \overline{{c}_{ab} c}\end{matrix} ] & = & [ \begin{matrix}1 & 1 & 1 \\ 0 & 1 & {c}_{a b} \\ 0 & 0 & 1\end{matrix} ] & [ \begin{matrix}{λ}_{a} \\ {λ}_{b} \\ {λ}_{c}\end{matrix} ]\end{matrix}$$

The first simplex, the second simples, the third simplex and/or the fourth simplex may be gradient boosted.

λ=T⁻¹S₁ may calculate barycentric coordinates from the first simplex, the second simplex, the third simplex and the fourth simplex. The method may include receiving a fifth data point. The fifth data point may be assigned the variable name x. The fifth data point may be plotted within the two-dimensional simplex, ŷ=y_{abc}T⁻¹ S₁(x) may identify a quantity y within a space of the two-dimensional simplex. The quantity y may be a low-dimensional solution of a high dimensional problem.

Each data point included in the plurality of data points may, in a Cartesian two-dimensional space, project onto a reconstruction. The reconstruction may be the reconstruction error value. The reconstruction may refer to reconstruction or a new data point.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

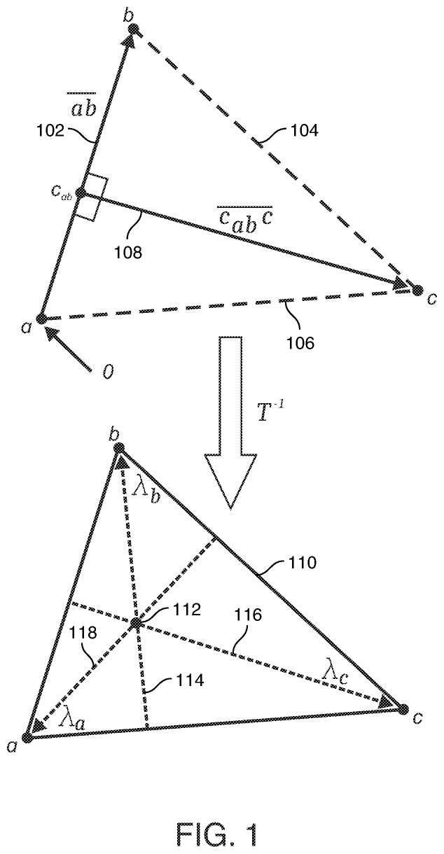

FIG. 1 shows an illustrative diagram. The illustrative diagram shows three points and two line segments being transformed into a combination space.

The top diagram in FIG. 1 includes line segments ab and cabc. Line segment ab, shown at 102, may correspond to a naïve prior projected on one or more previous experiences. Point cab may correspond to the reconstruction of new experience c, as projected on line segment ab. Line segment cabc, shown at 108, may identify the error between new experience c and previous experience ab. As such, line segment cabc may quantify new point c as a new experience.

Dotted lines 104 and 106 may indicate that line segments ab and cabc may be transformed into a combination space or triangle. In order to encode the line segments into a combination space, an inverse coactivation matrix may be used.

Simplex abc may be generated using the following coactivation matrix:

$$\begin{matrix}{S}_{1} & = & T & λ \\ [ \begin{matrix}\frac{1}{ab} \\ \overline{{c}_{ab} c}\end{matrix} ] & = & [ \begin{matrix}1 & 1 & 1 \\ 0 & 1 & {c}_{a b} \\ 0 & 0 & 1\end{matrix} ] & [ \begin{matrix}{λ}_{a} \\ {λ}_{b} \\ {λ}_{c}\end{matrix} ]\end{matrix} . \qquad Equation F : Coactivation matrix$$

In order to plot T as a simplex, the inverse of T, also referred to as T⁻¹, may be used. In order to create a coactivation matrix, a neuron that always returns one may be used. In one example, the “always-on” neuron (or corner of the simplex) may be a. The coactivation matrix may be inverted. The inverted coactivation matrix may be shown in equation G.

$$\begin{matrix}\begin{matrix}{T}^{- 1} & & λ\end{matrix} \\ [ \begin{matrix}0 & 0 & 0 \\ 1 & 0 & u ndetermined \\ 1 & 1 & 0\end{matrix} ] [ \begin{matrix}{λ}_{a} \\ {λ}_{b} \\ {λ}_{c}\end{matrix} ]\end{matrix} \qquad Equation G : Inverted Coactivation Matrix$$

The inverted coactivation matrix, or TV, may display the coordinates used to generate the simplex. It should be noted that, because the simplex, shown above, has three dimensions, each coordinate can be plotted in either two or three dimensions. As such, it may not be imperative to identify the underdetermined data point indicated in the second coordinate. It should be further noted that a simplex may include greater than three dimensions. As such, each coordinate may be plotted in the number of dimensions included in the simplex.

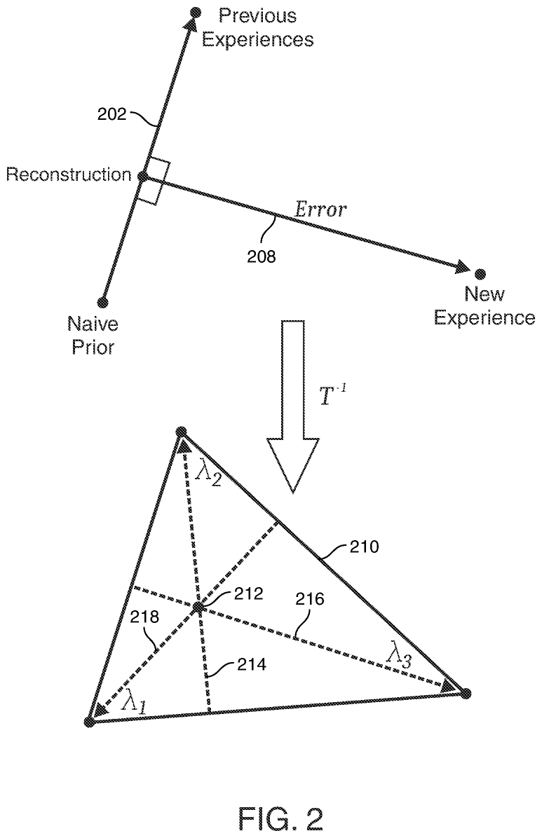

FIG. 2 shows an illustrative diagram. The diagram shows a naïve prior. It should be noted that any other suitable prior may be used in such an example. The naïve prior may be projected onto previous experiences, as shown at 202. When the naïve prior is projected onto previous experiences, which may be referred to as reconstruction, a reconstruction error value may be generated. It should be noted that the reconstruction error value may be the value in which the new experience does not match any previous experiences. As such, the reconstruction error value may identify the new experience, as shown at 208.

FIG. 2 may correspond to FIG. 1. As such, point a, shown in FIG. 1, or λₐ, shown in FIGS. 1 and 2, may indicate the naïve prior, point b, shown in FIG. 1, or λ_{b}, shown in FIGS. 1 and 2, may indicate the previous experience and point c, shown in FIG. 1 or λ_{c}, shown in FIGS. 1 and 2, may indicate the new experience. Line segment ab may be represented by a neuron that may encode a to b. Point cab may represent the new experience projected onto line segment ab. Line segment cabc may be represented by a neuron that may encode cab to c.

The line segments may be transformed into a simplex using the following method: generate a coactivation matrix of line segments ab and cabc; invert the coactivation matrix to generate an inverse coactivation matrix; multiply the weights of the neurons by the inverse coactivation matrix; this may convert the neurons from neurons that encode errors to neurons that encode a simplex. The thresholds may be recalculated.

Another method may be as follows: take points a, b and c, push points a, b and c through the neurons that encode point a, line segment ab and line segment cabc to generate a coactivation matrix. The coactivation matrix is inverted. The coactivation matrix inverse is multiplied by the weight matrix to yield a weight prime matrix. In order to get a threshold prime, one can solve for point: a maximizing the a neuron, point b maximizing the b neuron and point c maximizing the c neuron. The result may be the simplex, or combination space.

Dotted lines 214, 216 and 218 shows the definition of the combination space, from a corner of the simplex to the opposite line.

Point 212 shows the middle point of the simplex. A data point that is plotted in the middle of the simplex corresponds to a maximally unsure model. An example of a data structure that may be plotted at point 212, may be a data structure that has 33.33% correspondence to point a, 33.33% correspondence to point b, 33.33% correspondence to point c.

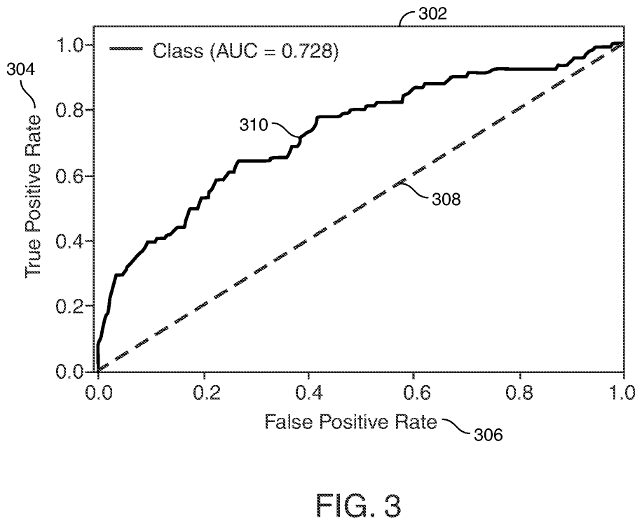

FIG. 3 shows an illustrative diagram. The illustrative diagram shows graph 302. Graph 302 shows the comparison between data structures classified, using Simplicial Human Inspired Pattern Identification as true positives and data structures classified as false positives. The y-axis indicates a true positive rate, as shown at 304. The x-axis indicates a false positive rate, as shown at 306. An exemplary one-to-one correlation line is drawn. The one-to-one correlation line is shown at 308. Line 310 shows a plotted line, in which data structures may be plotted on the graph. The area under to the curve (“AUC”) of line 310 may be 0.728 or 72.8%. As such, 72.8% of the total amount of plotted data structures may be under the curve

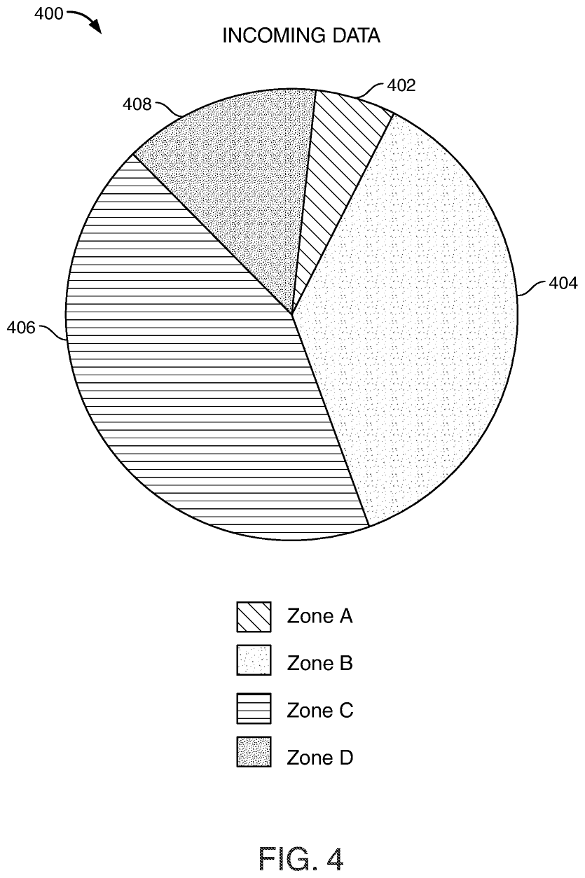

FIG. 4 shows an illustrative diagram 400. Illustrative diagram 400 may show a pie chart identifying a data structure based on a simplicial structure. The pie chart may a data structure plotted on a simplicial structure. The data structure may be related to four different points on the simplicial structure. As such, the pie chart may show four different zones. The simplicial structure from which the pie chart was culled may include four or more end points.

The data structure may be identified as corresponding to zone a, zone b, zone c and zone d. Zone a is shown at 402. Zone b is shown at 404. Zone c is shown at 406. Zone d is shown at 408.

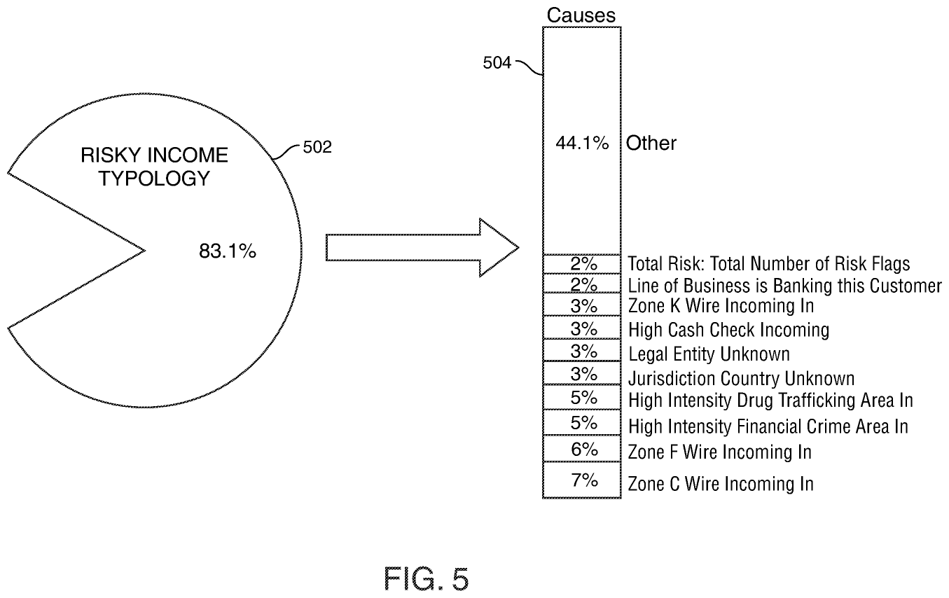

FIG. 5 shows an illustrative diagram. The illustrative diagram shows a pie chart and breakdown on a pie chart created from a simplicial structure.

In this example, the simplicial structure may be used to identify people of malicious intent. People of malicious intent may be identified based on incoming finances as well as outgoing finances. As such, each corner of a simplicial structure designed to capture people of malicious intent may identify a different type of malicious intent, such as check malicious intent, wire malicious intent or any other suitable malicious intent. One corner of the simplicial structure may identify a person of no malicious intent. Each corner of the simplicial structure may be referred to as a typology.

As such, each person plotted within the simplicial structure may be identified as either a person of no malicious intent or a person of malicious intent (and one or more types of malicious intent with which the person is associated), or a combination of the types of malicious intent and no malicious intent. The point in which the person plots on the simplicial structure may be transformed into a pie chart at least because each point within the simplicial structure is a specific distance from each end point within the simplicial structure. As such, in order to generate a pie chart that corresponds to the person, a determination of the length between the point on the pie chart and each end point of the simplicial structure may be identified. It should be further noted that each of the lengths between the point on the pie chart and each end point may be combined to a whole (which may be identified as 1, 100%, 100 or any other suitable numerical notation. Therefore, the lengths may be plotted on a pie chart, which intrinsically adds up to a whole.

Pie chart 502 may correspond to a person. Pie chart 502 may add up to a whole, or 100%. Pie chart 502 may include 83.1% risky income and 16.9% bland income. The causes for the 83.1% risky income may be shown at 504. The risky income may include 56% other, or undefined reasons for risky income.

2% may be the total risk for the person. For example, a person with multiple risk flags may include more risk because of the various risks with which the person is involved.

2% may be the line of business, also referred to as LOB, which is banking the customer. For example, in certain LOBs, such as checking account opening lines of business, minimal know your customer (“KYC”) or due diligence is identified regarding the customer. In other LOBs, such as private banking lines of business, large amounts of KYC or due diligence is identified regarding the customer. Therefore, LOBs that have less KYC or due diligence may have a larger amount of risk than LOBs that have more KYC or due diligence.

3% may be zone K wires incoming. Zone K wires may be electronic transfers incoming to an account from a zone K. A zone K may be geographic location or virtual location under one or more sanctions, such as international sanctions.

3% may be high cash checking incoming. The high cash checking incoming may be incoming funds that cashed at a high check cashing rate.

3% may be legal entity unknown. Legal entity unknown may be incoming funds coming from an entity that is a legal entity, as opposed to a person. However, a system may be unable to identify the type and/or identity of the legal entity.

3% may be a jurisdiction entity unknown. Jurisdiction entity unknown may be incoming funds from the entity of which the jurisdiction is unknown.

5% may be high intensity drug trafficking area in. High intensity drug trafficking area in may be incoming funds from geographical locations that have been identified as high intensity drug trafficking areas.

5% may be high intensity financial crime area in. High intensity financial crime area in may be incoming funds from geographical locations that have been identified as high intensity financial crime areas.

6% may be zone F incoming wires. Zone F wires may be electronic transfers incoming to an account from a zone F. A zone F may be geographic location or virtual location under one or more sanctions, such as international sanctions.

7% may be zone C incoming wires. Zone C wires may be electronic transfers incoming to an account from a zone C. A zone C may be geographic location or virtual location under one or more sanctions, such as international sanctions.

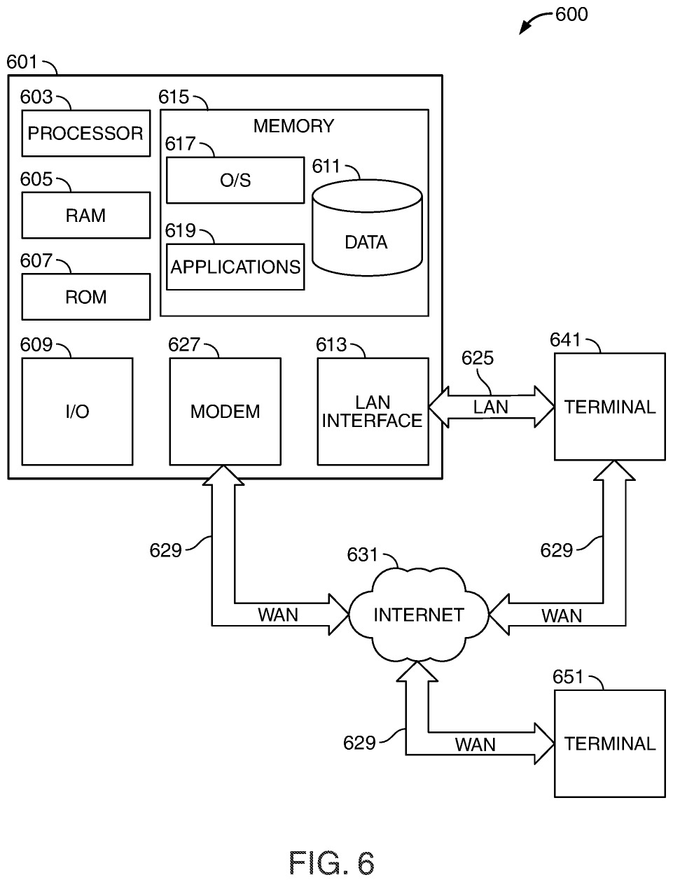

FIG. 6 shows an illustrative block diagram of system 600 that includes computer 601. Computer 601 may alternatively be referred to herein as a “server” or a “computing device.” Computer 601 may be a workstation, desktop, laptop, tablet, smart phone, or any other suitable computing device. Elements of system 600, including computer 601, may be used to implement various aspects of the systems and methods disclosed herein.

Computer 601 may have a processor 603 for controlling the operation of the device and its associated components, and may include RAM 605, ROM 607, input/output module 609, and a memory 615. The processor 603 may also execute all software running on the computer—e.g., the operating system and/or voice recognition software. Other components commonly used for computers, such as EEPROM or Flash memory or any other suitable components, may also be part of the computer 601.

The memory 615 may comprise any suitable permanent storage technology e.g., a hard drive. The memory 615 may store software including the operating system 617 and application(s) 619 along with any data 611 needed for the operation of the system 600. Memory 615 may also store videos, text, and/or audio assistance files. The videos, text, and/or audio assistance files may also be stored in cache memory, or any other suitable memory. Alternatively, some or all of computer executable instructions (alternatively referred to as “code”) may be embodied in hardware or firmware (not shown). The computer 601 may execute the instructions embodied by the software to perform various functions.

Input/output (“I/O”) module may include connectivity to a microphone, keyboard, touch screen, mouse, and/or stylus through which a user of computer 601 may provide input. The input may include input relating to cursor movement. The input may relate to transaction pattern tracking and prediction. The input/output module may also include one or more speakers for providing audio output and a video display device for providing textual, audio, audiovisual, and/or graphical output. The input and output may be related to computer application functionality. The input and output may be related to transaction pattern tracking and prediction.

System 600 may be connected to other systems via a local area network (LAN) interface 613.

System 600 may operate in a networked environment supporting connections to one or more remote computers, such as terminals 641 and 651. Terminals 641 and 651 may be personal computers or servers that include many or all of the elements described above relative to system 600. The network connections depicted in FIG. 6 include a local area network (LAN) 625 and a wide area network (WAN) 629, but may also include other networks. When used in a LAN networking environment, computer 601 is connected to LAN 625 through a LAN interface or adapter 613. When used in a WAN networking environment, computer 601 may include a modem 627 or other means for establishing communications over WAN 629, such as Internet 631.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit a user to retrieve web pages from a web-based server. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 619, which may be used by computer 601, may include computer executable instructions for invoking user functionality related to communication, such as e-mail, Short Message Service (SMS), and voice input and speech recognition applications. Application program(s) 619 (which may be alternatively referred to herein as “plugins,” “applications,” or “apps”) may include computer executable instructions for invoking user functionality related to performing various tasks. The various tasks may be related to transaction pattern tracking and prediction.

Computer 601 and/or terminals 641 and 651 may also be devices including various other components, such as a battery, speaker, and/or antennas (not shown).

Terminal 651 and/or terminal 641 may be portable devices such as a laptop, cell phone, Blackberry™, tablet, smartphone, or any other suitable device for receiving, storing, transmitting and/or displaying relevant information. Terminals 651 and/or terminal 641 may be other devices. These devices may be identical to system 600 or different. The differences may be related to hardware components and/or software components.

Any information described above in connection with database 611, and any other suitable information, may be stored in memory 615. One or more of applications 619 may include one or more algorithms that may be used to implement features of the disclosure, and/or any other suitable tasks.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

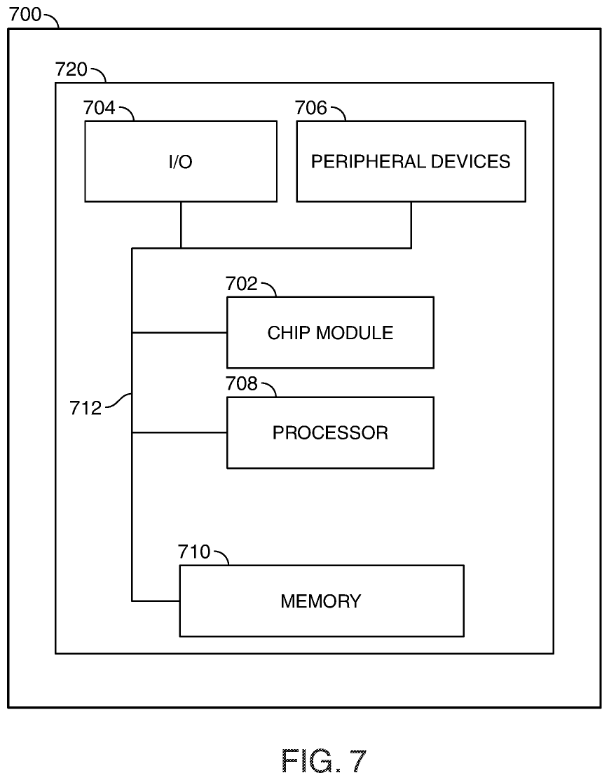

FIG. 7 shows illustrative apparatus 700 that may be configured in accordance with the principles of the disclosure. Apparatus 700 may be a computing machine. Apparatus 700 may include one or more features of the apparatus shown in FIG. 6. Apparatus 700 may include chip module 702, which may include one or more integrated circuits, and which may include logic configured to perform any other suitable logical operations.

Apparatus 700 may include one or more of the following components: I/O circuitry 704, which may include a transmitter device and a receiver device and may interface with fiber optic cable, coaxial cable, telephone lines, wireless devices, PHY layer hardware, a keypad/display control device or any other suitable media or devices; peripheral devices 706, which may include counter timers, real-time timers, power-on reset generators or any other suitable peripheral devices; logical processing device 708, which may compute data structural information and structural parameters of the data; and machine-readable memory 710.

Machine-readable memory 710 may be configured to store in machine-readable data structures: machine executable instructions (which may be alternatively referred to herein as “computer instructions” or “computer code”), applications, signals, and/or any other suitable information or data structures.

Components 702, 704, 706, 708 and 710 may be coupled together by a system bus or other interconnections 712 and may be present on one or more circuit boards such as 720. In some embodiments, the components may be integrated into a single chip. The chip may be silicon-based.

Thus, systems and methods for simplicial human-inspired pattern identification is provided. Persons skilled in the art will appreciate that the present invention can be practiced by other than the described embodiments, which are presented for purposes of illustration rather than of limitation. The present invention is limited only by the claims that follow.

What is claimed is:

1. A method for generating a simplex from a plurality of neurons, the method comprising:
receiving a plurality of neurons, each neuron, included in the plurality of neurons, encoding a data point;
receiving a new data point;
projecting the new data point on the plurality of neurons;
generating a reconstruction error value between the new data point and the plurality of neurons, the reconstruction error value quantifying the new data point;
creating a coactivation matrix for each of the neurons included in the plurality of neurons and the reconstruction error value;
inverting the coactivation matrix;
identifying, from the inverted coactivation matrix, two or three coordinates for each end point of a simplex;
generating the simplex from the two or three coordinates identified for each end point of the simplex;
receiving a data structure;
plotting the data structure within the simplex;
identifying, for each end point, a correspondence value between the data structure and the end point, where the correspondence values for each of the end points add up to 100%; and
displaying a pie chart, for the data structure, that includes identifiers for each of the end points and the correspondence values.

2. The method of claim 1, wherein the data point corresponds to an experience.

3. A method for naïve tessellation of a topologically continuous subspace, the method comprising:
receiving a plurality of data points;
assigning each data point, included in the plurality of data points, a zero value;
identify that a first data point, included in the plurality of data points, is not a second data point, included in the plurality of data points;
encode a line segment between the first data point and the second data point;
reconstruct each of the plurality of data points by projecting each of the plurality of data points onto the line segment;
identify that a third data point, included in the plurality of data points, includes a component that is orthogonal to:
a first simplex that encodes the first data point;
a second simplex that encodes the second data point;
a third simplex that encodes the line segment between the first data point and the second data point; and
a fourth simplex that encodes zero;
use the line segment, a second line segment that encodes (the third data point, the first line segment and the third data point) the first simplex, the second simplex, the third simplex and the fourth simplex to form a reconstruction error value; and
use the reconstruction error value, the line segment, the second line segment, the third data point, the first simplex, the second simplex, the third simplex and the fourth simplex to generate a two-dimensional simplex.

4. The method of claim 3 wherein each data point, included in the plurality of data points, in a Cartesian two-dimensional space, project onto a reconstruction.

5. The method of claim 3 wherein the corners of the two-dimensional simplex are the first data point, the second data point and the third data point.

6. The method of claim 3 where each of the corners of the two-dimensional simplex are calculated by T⁻¹ S₁, where S is the simplex, T is a coactivation matrix, a is the first data point, b is the second data point and c is the third data point:
$$\begin{matrix}{S}_{1} & = & T & λ \\ [ \begin{matrix}\frac{1}{ab} \\ \overline{{c}_{ab} c}\end{matrix} ] & = & [ \begin{matrix}1 & 1 & 1 \\ 0 & 1 & {c}_{a b} \\ 0 & 0 & 1\end{matrix} ] & [ \begin{matrix}{λ}_{a} \\ {λ}_{b} \\ {λ}_{c}\end{matrix} ]\end{matrix}$$

7. The method of claim 6 further comprising gradient boosting the first simplex, the second simplex, the third simplex and the fourth simplex.

8. The method of claim 7 where λ=T⁻¹S₁ calculates the barycentric coordinates from the first simplex, the second simplex, the third simplex and the fourth simplex.

9. The method of claim 3 further comprising receiving a fifth data point assigned the variable name x, where the fifth data point is plotted within the two-dimensional simplex, ŷ=y_{abc}T⁻¹ S₁(x) identifies a quantity y within a space of the two-dimensional simplex.

10. The method of claim 9 wherein the quantity y is a low-dimensional solution of a high dimensional problem.

11. A system for generating a two-dimensional simplex from a plurality of neurons, the system comprising:
a receiver operable to receive:
a plurality of neurons, each neuron included in the plurality of neurons encoding a data point;
a new data point;
a hardware processor operable to:
project the new data point on the plurality of neurons;
generate a reconstruction error value between the new data point and the plurality of neurons, the reconstruction error value quantifying the new data point;
create a coactivation matrix for each of the neurons included in the plurality of neurons and the reconstruction error value;
invert the coactivation matrix;
identify, from the inverted coactivation matrix, two or more coordinates for each end point of a simplex;
generate the simplex from the two or more coordinates identified for each point of the simplex;
receive a data structure;
plot the data structure within the simplex; and
identify, for each end point of the simplex, a correspondence value between the data structure and the end point, where all of the correspondence values for each of the end points add up to 100%.

12. The system of claim 11 wherein the hardware processor is further operable to display a pie chart, for the data structure, that includes identifiers for each of the end points and the correspondence values.

13. The system of claim 11, wherein the neurons are received from an artificial intelligence neural network.

14. The system of claim 11, wherein each of the neurons included in the plurality of neurons correspond to an experience.

15. The system of claim 11 wherein the new data point corresponds to a new experience.
